(19) United States
(12) Patent Application Publication
(10) Pub. No.: US 2025/0296186 A1
(43) Pub. Date: Sep. 25, 2025

(54) CHIP COLLECTION APPARATUS

(71) Applicant: OKUMA CORPORATION, Niwa-gun (JP)

(72) Inventor: Tetsunobu Nishinaka, Niwa-gun (JP)

(73) Assignee: OKUMA CORPORATION, Niwa-gun (JP)

(21) Appl. No.: 19/082,609

(22) Filed: Mar. 18, 2025

(30) Foreign Application Priority Data
Mar. 19, 2024 (JP) 2024-043737

(51) Int. Cl. B23Q 11/00

(52) U.S. Cl. CPC B23Q 11/0067; B23Q 11/0053

(57) ABSTRACT

Provided is a chip collection apparatus that enables efficient chip discharge, overcomes troubles caused by chip buildup, and enables elimination of maintenance such as cleaning work. A chip collection apparatus includes a belt conveyor that transports chips to a chip discharge part, a conveyor frame designed to cause a bottom plate located below the belt conveyor to receive chips that have fallen from the belt conveyor, and a washing mechanism that ejects washing fluid for discharging chips to outside the conveyor frame. The bottom plate of the conveyor frame has such a shape in transverse cross section that the bottom plate is deeper toward the center. The washing mechanism has a bottom-plate washing nozzle that ejects the washing fluid such that chips received on the bottom plate are directed toward the chip discharge part.

### TECHNICAL FIELD

The present invention relates to a chip collection apparatus for collecting chips produced from various types of machine tools.

### BACKGROUND ART

As such a chip collection apparatus, known apparatus includes: one in which a belt conveyor, referred to as a chip conveyor, is used (for example, Patent Literature 1); one in which the belt conveyor is not used, but instead a chip collection chute is used for collection (for example, Patent Literature 2); and so on.

A conventional chip collection apparatus (1), on which the present invention is based, includes, as shown in FIG. 3 and FIG. 4, a belt conveyor (2), and a conveyor frame (3) that houses the belt conveyor (2) thereinside.

The belt conveyor (2) is for collecting chips, which is referred to as a chip conveyor, and is a caterpillar-type belt conveyor (2) including a large number of hinges (4), with the adjacent hinges (4) being connected to each other.

The belt conveyor (2) is provided at left and right sides thereof with a drive unit that is not shown. This drive unit causes the belt conveyor (2) to rotate in a loop in an endless manner inside the conveyor frame (3). In FIG. 3, the belt conveyor (2), as shown by horizontal arrows, has: a horizontal forward path (2a) that runs leftward on the upper side, extending from the inside to the outside of a machine tool; and a horizontal return path (2b) that runs rightward on the lower side, returning to the inside of the machine tool.

The belt conveyor (2), on the forward path (2a), moves forward (leftward in FIG. 3) while receiving chips falling from above together with cutting fluid (coolant), reaches a chip discharge part (2c) that is a terminal end portion of the forward path (2a), causes the chips and cutting fluid (coolant) to fall down to a receiving tray (5) disposed below the chip discharge part (2c) to discharge them, and thereafter, on the return path (2b), moves backward (rightward in FIG. 3) along the bottom plate (3a) of the conveyor frame (3). The chips that have fallen down to the receiving tray (5) are received and held at a mesh-shaped bottom part of the receiving tray (5), and the cutting fluid (coolant) that has passed through the mesh-shaped bottom part are stored in a tank (6) disposed below the receiving tray (5).

### CITATION LIST

### Patent Literature

[Patent Literature 1] Japanese Unexamined Utility Model Application Publication No. H5-19229

### [Patent Literature 2] Japanese Unexamined Patent Application Publication No. JP-A-2017-185585

### SUMMARY OF INVENTION

### Technical Problem

In the above-described chip collection apparatus (1), there is a problem that chips adhere to the hinge (4) portions of the belt conveyor (2), which portions are shown as areas “A” in FIG. 3 and FIG. 4, and chips build up at the bottom plate (3a) portions of the conveyor frame (3), which portions are shown as areas “B” in FIG. 3 and FIG. 4. Thus, enabling efficient chip discharge, overcoming troubles caused by chip buildup, and reducing maintenance such as cleaning work are desired.

With the apparatus disclosed in Patent Literature 1, in addition to a chip bucket to store chips generally discharged from the chip conveyor, a chip collection box to collect chips that adhere to the surface of the hinges needs to be disposed separately. Further, in a case where chips fail to enter the chip collection box at the time of washing, the chips end up building up on the bottom plate of the chip conveyor. In that case, there arises a problem that maintenance such as cleaning work is increased.

With the apparatus disclosed in Patent Literature 2, the apparatus does not have a belt conveyor and has only a chip collection chute. In this configuration, in a case where chips are generated in large amount and get tangled up with each other to form a large mass, a large amount of washing fluid is required to discharge such a large mass of chips. Therefore, there arises a problem that the size of a tank and a pump to be used for supplying washing fluid is increased. In addition, in a case of the machine tool having a large size, since the path until the chips are discharged is long, there is a risk of chips being remained in the collection chute, and therefore, there arises a problem that maintenance such as cleaning work is increased.

An object of the present invention is to overcome a problem to be solved that chips build up at a portion of the bottom plate of the conveyor frame and a problem to be solved that chips adhere to a portion of the hinges of the belt conveyor, thereby providing a chip collection apparatus in which cleaning inside the conveyor does not have to be conducted for a long time.

### Solution to Problem

The present invention consists of the following aspects, in order to achieve the above-described object.

1) A chip collection apparatus including: a belt conveyor disposed so as to be rotatable in a loop, and configured to transport chips to a chip discharge part located frontward; a conveyor frame that houses the belt conveyor thereinside, and is configured to cause a bottom plate located below the belt conveyor to receive chips that have fallen from the belt conveyor; and a washing mechanism configured to eject washing fluid, the washing fluid being for discharging chips to outside the conveyor frame,
the chip collection apparatus characterized in that the bottom plate has such a shape in transverse cross section that the bottom plate is deeper toward a center thereof, and the washing mechanism has a bottom-plate washing nozzle configured to eject the washing fluid such that chips received on the bottom plate are directed toward the chip discharge part side.

2) The chip collection apparatus according to the above-described aspect 1), wherein the washing mechanism further has a conveyor washing nozzle configured to eject the washing fluid such that chips that have adhered to a surface of the belt conveyor fall down to the bottom plate.

3) The chip collection apparatus according to the above-described aspect 2), wherein washing by the bottom-plate washing nozzle and washing by the conveyor washing nozzle are simultaneously performed.

4) A chip collection apparatus including: a belt conveyor disposed so as to be rotatable in a loop, and configured to transport chips to a chip discharge part located frontward; a conveyor frame that houses the belt conveyor thereinside, and is configured to cause a bottom plate located below the belt conveyor to receive chips that have fallen from the belt conveyor; and a washing mechanism configured to eject washing fluid, the washing fluid being for discharging chips to outside the conveyor frame,
the chip collection apparatus characterized in that: the washing mechanism has a bottom-plate washing nozzle configured to eject the washing fluid such that chips received on the bottom plate are directed toward the chip discharge part side, and a conveyor washing nozzle configured to eject the washing fluid such that chips that have adhered to a surface of the belt conveyor fall down to the bottom plate; and washing by the bottom-plate washing nozzle and washing by the conveyor washing nozzle are simultaneously performed.

5) The chip collection apparatus according to the above-described aspect 3) or 4), wherein the bottom-plate washing nozzle configured to eject the washing fluid in a horizontal direction and the conveyor washing nozzle configured to eject the washing fluid obliquely upward are disposed so as to bifurcate from a washing-fluid supply pipe configured to supply the washing fluid to a vicinity of a rear end portion of the bottom plate.

### Advantageous Effects of Invention

In accordance with the chip collection apparatus according to the above-described aspect 1), chips generated in the machine tool, together with cutting fluid (coolant), fall down to the belt conveyor from above, are received by the belt conveyor to reach the chip discharge part, and fall down from the belt conveyor under their own weights to be discharged. Here, regarding relatively large chips, almost all of such chips are discharged at the chip discharge part. Regarding relatively small chips, some of such chips are carried away together with cutting fluid (coolant) or fall down from the belt conveyor under their own weights, thereby building up on the bottom plate of the conveyor frame, and others do not fall down from the belt conveyor at the chip discharge part, which end up building up on the belt conveyor.

To deal with this situation, in the chip collection apparatus according to the above-described aspect 1), in order to discharge chips that have fallen from the belt conveyor to build up on the bottom plate of the conveyor frame, the shape of the bottom plate is made an appropriate shape (the shape in which its transverse cross section is deeper toward the center) and the bottom-plate washing nozzle for sending out the chips that have fallen down to the bottom plate toward the chip discharge part side is disposed.

Because of this configuration, the chips that have fallen from the belt conveyor roll down a slanted surface of the bottom plate whereby these chips are gathered at a very bottom (center part) of the bottom plate; while washing fluid from the bottom-plate washing nozzle is ejected toward the center part of the bottom plate whereby chips are efficiently discharged to a receiving tray (toward the chip discharge part side). Thus, one of the problems to be solved that chips build up at a portion of the bottom plate of the conveyor frame is overcome, whereby a chip collection apparatus in which cleaning inside the apparatus does not have to be conducted for a long time is obtained.

In accordance with the chip collection apparatus according to the above-described aspect 2), in order to discharge chips that do not fall down from the belt conveyor and build up on the belt conveyor, the conveyor washing nozzle is added as a washing nozzle other than the bottom-plate washing nozzle. Because of this configuration, chips that have adhered to the surface of the belt conveyor are washed away with the conveyor washing nozzle. Chips that are washed away are gathered at the very bottom of the bottom plate, and are discharged by the bottom-plate washing nozzle, together with chips that have fallen from the belt conveyor. Thus, the other problem to be solved that chips adhere to a portion of the hinges of the belt conveyor is also overcome, whereby a chip collection apparatus in which cleaning inside the apparatus does not have to be conducted for a long time is obtained.

As a matter of course, the bottom-plate washing nozzle of the above-described aspect 1) and the conveyor washing nozzle of the above-described aspect 2) may be controlled independently from each other. However, in accordance with the chip collection apparatus of the above-described aspect 3), washing the belt conveyor surface and washing the bottom plate of the conveyor frame are simultaneously performed. In this configuration, washing fluid that was used to wash the belt conveyor surface flows down to the very bottom of the bottom plate, which enables the increase of the flow rate of the washing fluid that is used to wash the very bottom of the bottom plate, whereby chips that build up on the bottom plate are more efficiently discharged.

That is, by using the bottom-plate washing nozzle and the conveyor washing nozzle in combination, the object to provide the chip collection apparatus in which cleaning inside the apparatus does not have to be conducted for a long time is realized. However, in a case where washing fluid that was used to wash the belt conveyor surface is not used to wash the bottom plate of the conveyor frame, there is a need to employ a large-sized pump and/or to increase the number of pumps in order to secure the flow rate necessary for washing, and therefore, there arises a problem in terms of cost and consumption energy.

In contrast, in accordance with the chip collection apparatus according to the above-described aspect 3), by employing such a configuration that the washing fluid that was used to wash the belt conveyor surface and the washing fluid that was used to wash the bottom plate of the conveyor frame merge into each other, chips are efficiently discharged while securing the flow rate of the washing fluid necessary for washing, without increasing the size of the pump and/or increasing the number of the pumps.

In accordance with the chip collection apparatus according to the above-described aspect 4), by simultaneously performing washing of the belt conveyor surface and washing of the bottom plate of the conveyor frame with use of two washing nozzles, i.e., the bottom-plate washing nozzle and the conveyor washing nozzle, the problem to be solved that chips build up at a portion of the bottom plate of the conveyor frame and the problem to be solved that chips adhere to the belt conveyor are simultaneously overcome regardless of the shape of the bottom plate of the conveyor frame, whereby a chip collection apparatus in which cleaning inside the apparatus does not have to be conducted for a long time is obtained.

In accordance with the chip collection apparatus according to the above-described aspect 5), the number of the washing-fluid supply pipe for supplying washing fluid is limited to only one, and ejecting directions of the two washing nozzles that bifurcate from this washing-fluid supply pipe are varied. Thus, washing the belt conveyor surface and washing the bottom plate are simultaneously performed, whereby the configuration of the apparatus is simplified.

### BRIEF DESCRIPTION OF THE DRAWINGS

FIG. 1 illustrates a chip collection apparatus in its entirety according to an embodiment of the present invention.

FIG. 2 is a view showing a simplified transverse cross section taken along the line II-II of FIG. 1.

FIG. 3 illustrates a conventional chip collection apparatus in its entirety according to an embodiment.

FIG. 4 is a view showing a simplified transverse cross section taken along the line IV-IV of FIG. 3.

### DETAILED DESCRIPTION OF EMBODIMENTS

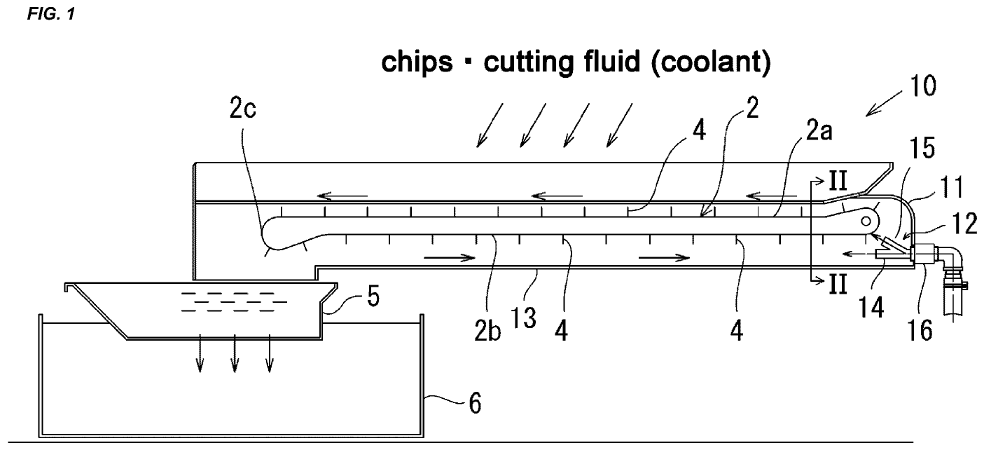

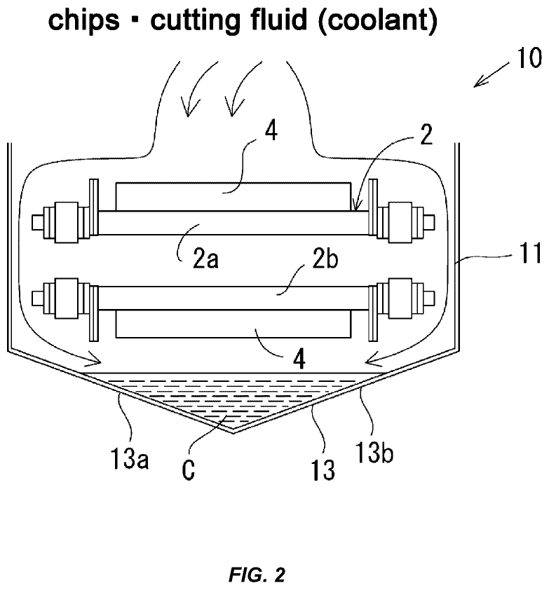

Hereinafter, referring to FIG. 1 and FIG. 2, an embodiment of the present invention will be described.

A chip collection apparatus (10) in this embodiment includes a belt conveyor (2), a conveyor frame (11) that houses the belt conveyor (2) thereinside, a receiving tray (5), a tank (6), and a washing mechanism (12).

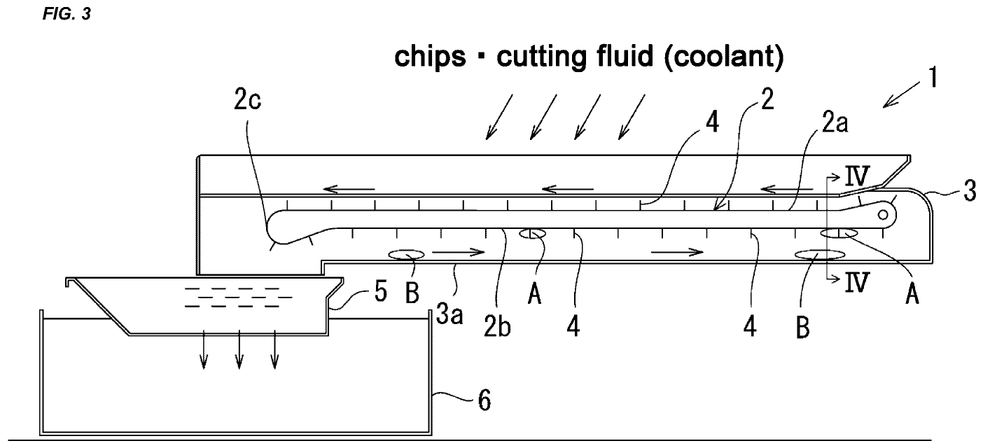

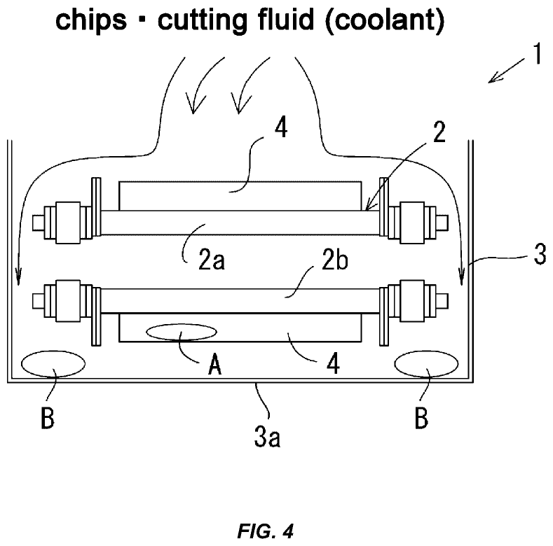

The belt conveyor (2), the receiving tray (5), and the tank (6) have the same configuration as those of the conventional chip collection apparatus (1) shown in FIG. 3 and FIG. 4.

The differences from the conventional chip collection apparatus (1) lie in: the shape of the bottom plate (13) of the conveyor frame (11); and the configuration of the washing mechanism (12). Hereinafter, the differences from the conventional chip collection apparatus (1) will be described in detail.

The bottom plate (13) of the conveyor frame (11) is located below the belt conveyor (2) and designed to receive chips that have fallen from the belt conveyor (2). This bottom plate (13) is, as shown in FIG. 2, V-shaped in transverse cross section, which is formed by left and right slanted parts (13a) and (13b), so that the bottom plate (13) has such a shape in transverse cross section that the bottom plate (13) is deeper toward a center thereof.

The washing mechanism (12) is disposed in the vicinity of a terminal end portion (right end portion in FIG. 1) of a return path (2b), where two types of nozzles (14) and (15), that is, a bottom-plate washing nozzle (14) that ejects washing fluid in the horizontal direction toward the center part in the left-right direction of the bottom plate (13) such that chips received on the bottom plate (13) are directed forward (in the direction toward the chip discharge part (2c) side), and a conveyor washing nozzle (15) that ejects the washing fluid obliquely upward such that chips that adhere to the belt conveyor (2) surface (lower surface of the return path (2b)) fall down onto the bottom plate (13), are arranged. These nozzles (14) and (15) are disposed so as to bifurcate from one washing-fluid supply pipe (16) that supplies the washing fluid to the vicinity of a rear end portion of the bottom plate (13).

In accordance with the chip collection apparatus (10) according to the above-described embodiment, chips generated in the machine tool, as shown by arrows in the drawings, fall down to the belt conveyor (2) from above together with cutting fluid (coolant), and are received on the forward path (2a) of the belt conveyor (2) to reach the chip discharge part (2c). Then, most of such chips fall down to the receiving tray (5) under their own weights to be collected.

Here, regarding chips whose own weights are relatively large, almost all of such chips are discharged at the chip discharge part (2c). Regarding chips whose own weights are relatively small, some of such chips are carried away together with cutting fluid (coolant) or fall down from the belt conveyor under their own weights, thereby reaching the bottom plate (13) of the conveyor frame (11) to build up (see areas indicated as “B” in FIG. 3 and FIG. 4), and others do not fall down from the belt conveyor (2) at the chip discharge part (2c), which adhere to the lower surface of the return path (2b) of the belt conveyor (2), ending up building up on the surface of the belt conveyor (2) that rotates in a loop (see areas indicated as “A” in FIG. 3 and FIG. 4).

Regarding chips that build up on the bottom plate (13) of the conveyor frame (11) and on the surface of the belt conveyor (2), cleaning (maintenance) is required. In accordance with the chip collection apparatus (10) according to the above-described embodiment, by using two nozzles (the bottom-plate washing nozzle (14) and the conveyor washing nozzle (15)) of the washing mechanism (12), cleaning of chips that have built up is conducted, as follows.

First, the bottom-plate washing nozzle (14) ejects washing fluid toward the center part of the bottom plate (13) whereby chips that have fallen down to the bottom plate (13) are send to the receiving tray (5) located below the chip discharge part (2c).

The conveyor washing nozzle (15) ejects washing fluid toward the surface of the belt conveyor (2) whereby chips that adhere to the surface of the belt conveyor (2) are caused to fall down onto the bottom plate (13).

Here, chips that have fallen down to the bottom plate (13) of the conveyor frame (11), together with cutting fluid (coolant) and the washing fluid from the conveyor washing nozzle (15), gather at the center part (an area indicated as “C” in FIG. 2) of the bottom plate (13) under their own weights, owing to the configuration that the bottom plate (13) has such a shape in transverse cross section that the bottom plate (13) is deeper toward a center thereof. In this state, the bottom-plate washing nozzle (14) is used, whereby all the chips that have fallen down to the bottom plate (13) (including chips that had adhered to the surface of the belt conveyor (2)) are discharged to the receiving tray (5) by means of the washing fluid from the bottom-plate washing nozzle (14). In this way, the bottom plate (13) is washed by also using the cutting fluid (coolant) that was used in machining process.

As described above, in accordance with the chip collection apparatus (10) according to this embodiment, regarding the relatively small chips including chips that have fallen from the belt conveyor (2) and chips that adhere to the hinges (4), such chips are also discharged without building up. Therefore, the two problems, i.e., the problem that chips adhere to a portion of the hinges (4) of the belt conveyor (2), and the problem that chips build up at a portion of the bottom plate (13) of the conveyor frame (11), are simultaneously solved. As a result, cleaning inside the apparatus does not have to be conducted for a long time.

In addition, in accordance with the above-described chip collection apparatus (10), ejecting directions of the two washing nozzles (the bottom-plate washing nozzle (14) and the conveyor washing nozzle (15)) that bifurcate from one washing-fluid supply pipe (16) are varied, whereby washing of the belt conveyor (2) surface and washing of the bottom plate (13) of the conveyor frame (11) are simultaneously performed. With this configuration, washing fluid that was used to wash the belt conveyor (2) surface flows down to the very bottom of the bottom plate (13), which enables the increase of the flow rate of the washing fluid to be used to wash the very bottom of the bottom plate (13). As a result, the configuration of the chip collection apparatus (10) is simplified. In addition, chips that build up on the bottom plate (13) are more efficiently discharged.

In the conventional collection apparatus (1), although not shown, the conveyor washing nozzle is disposed at the chip discharge part (2c) (which is located at a terminal end portion of the forward path (2a)) so that chips are easily housed into the receiving tray (5). The bottom-plate washing nozzle (14), in order to achieve its end, needs to be disposed at the terminal end portion of the return path (2b). In the chip collection apparatus (10) according to the above-described embodiment, it is also possible to have an arrangement in which conveyor washing nozzle (15) is moved to the terminal end portion of the forward path (2a). Even in this modified arrangement (in which the bottom-plate washing nozzle (14) is located at the terminal end portion of the return path (2b), and the conveyor washing nozzle (15) is located at the terminal end portion of the forward path (2a)), it is possible to simultaneously solve the above-described two problems.

However, according to this modified arrangement, when compared with the arrangement of the above-described embodiment (in which both of the bottom-plate washing nozzle (14) and the conveyor washing nozzle (15) are arranged at the terminal end portion of the return path (2b), and washing of the belt conveyor (2) surface and washing of the bottom plate (13) are simultaneously performed), there is a need to employ a large-sized pump and/or to increase the number of pumps in order to secure the flow rate necessary for washing, and therefore, there arises a problem in terms of cost and consumption energy.

The chip collection apparatus (10) according to the above-described embodiment, as compared with the above-described modified arrangement, employs the configuration such that the washing fluid that was used to wash the belt conveyor (2) surface and the washing fluid that was used to wash the bottom plate (13) of the conveyor frame (11) merge into each other, thereby having an advantageous effect that chips are efficiently discharged while securing the flow rate of the washing fluid necessary for washing, without increasing the size of the pump and increasing the number of the pumps.

In addition, in accordance with the chip collection apparatus (10) according to the above-described embodiment, the bottom plate (13) is V-shaped in transverse cross section whereby chips and cutting fluid (coolant) are securely gathered at the center part “C” of the bottom plate (13) of the conveyor frame (11); and chips are caused to easily flow by heightening the liquid level of washing fluid in the bottom plate (13) of the conveyor frame (11) (or by increasing the rate of flow). As a result, the chip collecting efficiency is increased.

It is noted that, although, in the above-described embodiment, the bottom plate (13) is V-shaped in transverse cross section, which is formed by the left and right slanted parts (13a) and (13b), the bottom plate (13) does not have to be perfectly V-shaped, and may have a shape in which respective lower end portions of the left and right slanted parts (13a) and (13b) are connected by a flat part provided at the center part in the left-right direction of the bottom plate (13) or may have a shape in which the respective lower end portions of the left and right slanted parts (13a) and (13b) are connected by an arc part with the arc being concave downward, instead of the flat part. Furthermore, instead of being V-shaped in transverse cross section, the entire bottom plate (13) may have an arc shape with the arc being concave downward in transverse cross section. In short, the bottom plate (13) may have a variety of shapes in transverse cross section such that the bottom plate (13) is deeper toward a center thereof, whereby chips easily gather at the center part in the left-right direction of the bottom plate (13) under their own weights.

It is also noted that, regarding the bottom-plate washing nozzle (14), although the washing fluid is ejected in the horizontal direction in the above embodiment, the direction in which the washing fluid is directed is not limited to the horizontal direction and may be configured such that the washing fluid is ejected in a downwardly slanted direction as long as the bottom plate (13) is washed and the washing fluid is directed toward the chip discharge part (2c) side.

### REFERENCE SIGNS LIST

(2): belt conveyor
(2c): chip discharge part
(10): chip collection apparatus
(11): conveyor frame
(12): washing mechanism
(13): bottom plate
(14): bottom-plate washing nozzle
(15): conveyor washing nozzle
(16): washing-fluid supply pipe

1. A chip collection apparatus comprising: a belt conveyor disposed so as to be rotatable in a loop, and configured to transport chips to a chip discharge part located frontward; a conveyor frame that houses the belt conveyor thereinside, and is configured to cause a bottom plate located below the belt conveyor to receive chips that have fallen from the belt conveyor; and a washing mechanism configured to eject washing fluid, the washing fluid being for discharging chips to outside the conveyor frame,
the chip collection apparatus characterized in that the bottom plate has such a shape in transverse cross section that the bottom plate is deeper toward a center thereof, and the washing mechanism has a bottom-plate washing nozzle configured to eject the washing fluid such that chips received on the bottom plate are directed toward the chip discharge part side.

2. The chip collection apparatus according to claim 1, wherein the washing mechanism further has a conveyor washing nozzle configured to eject the washing fluid such that chips that have adhered to a surface of the belt conveyor fall down to the bottom plate.

3. The chip collection apparatus according to claim 2, wherein washing by the bottom-plate washing nozzle and washing by the conveyor washing nozzle are simultaneously performed.

4. A chip collection apparatus comprising: a belt conveyor disposed so as to be rotatable in a loop, and configured to transport chips to a chip discharge part located frontward; a conveyor frame that houses the belt conveyor thereinside, and is configured to cause a bottom plate located below the belt conveyor to receive chips that have fallen from the belt conveyor; and a washing mechanism configured to eject washing fluid, the washing fluid being for discharging chips to outside the conveyor frame,
the chip collection apparatus characterized in that: the washing mechanism has a bottom-plate washing nozzle configured to eject the washing fluid such that chips received on the bottom plate are directed toward the chip discharge part side, and a conveyor washing nozzle configured to eject the washing fluid such that chips that have adhered to a surface of the belt conveyor fall down to the bottom plate; and washing by the bottom-plate washing nozzle and washing by the conveyor washing nozzle are simultaneously performed.

5. The chip collection apparatus according to claim 3, wherein the bottom-plate washing nozzle configured to eject the washing fluid in a horizontal direction and the conveyor washing nozzle configured to eject the washing fluid obliquely upward are disposed so as to bifurcate from a washing-fluid supply pipe configured to supply the washing fluid to a vicinity of a rear end portion of the bottom plate.

6. The chip collection apparatus according to claim 4, wherein the bottom-plate washing nozzle configured to eject the washing fluid in a horizontal direction and the conveyor washing nozzle configured to eject the washing fluid obliquely upward are disposed so as to bifurcate from a washing-fluid supply pipe configured to supply the washing fluid to a vicinity of a rear end portion of the bottom plate.
